(19) United States
(12) Patent Application Publication
(10) Pub. No.: US 2008/0209009 A1
(43) Pub. Date: Aug. 28, 2008

(54) METHODS AND SYSTEMS FOR SYNCHRONIZING CACHED SEARCH RESULTS

(76) Inventors: Niraj Katwala, Hayward, CA (US); Timothy England, Pacifica, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/624,657

(22) Filed: Jan. 18, 2007

(51) Int. Cl. G06F 15/16

(52) U.S. Cl. 709/219

(57) ABSTRACT

Search result files are synchronized among multiple servers so that each of the servers stores copies of the search result files stored by others of the servers. Such synchronizing may be performed periodically. In cases where search result files stored at different servers have similar labels, older ones of the similarly labeled search result files may be replaced by newer ones thereof at each respective one of the servers during the synchronization process.

### FIELD OF THE INVENTION

The present invention relates to techniques for synchronizing cached search results among a plurality of servers.

### BACKGROUND

All major search engines cache results. Thus, if a user enters a search query for, say, “travel”, the search engine will first check its memory to see if it has already served a set of results to that query. If so (and assuming staleness criteria for the existing results are satisfied), no new search will be run and, instead, these previously stored results will be returned to the user. By returning the previously stored results rather than executing a new search against data stored on multiple hard drives, across multiple servers, to retrieve a fresh results list, the time taken to respond to the new query will be dramatically reduced from that which would be incurred in having to perform a new search.

Various schemes for caching search results exist. For example, different search engines may employ single-level caching, two-level caching or even three-level caching. See, e.g., X. Long & T. Suel, Three-level caching for efficient query processing in large web search engines, WWW 2005, May 10-14, 2005, Chiba, Japan. In some cases, accelerators that front server farms may store the cached results. E. P. Markatos, On caching search engine query results, Proceedings of the 5th International Web Caching and Content Delivery Workshop, May 2000. However, this can present a single point of failure if the accelerator were to fail. Hence, other schemes may involve the individual search engine servers caching their own search query results. While this approach avoids the accelerator as the single point of failure, it may eliminate (or at least severely reduce) the positive effects of load balancers.

### SUMMARY OF THE INVENTION

In one embodiment of the invention, search result files are synchronized among multiple servers so that each of the servers stores copies of the search result files stored by others of the servers. Such synchronizing may be performed periodically. In cases where search result files stored at different servers have similar labels, older ones of the similarly labeled search result files may be replaced by newer ones thereof at each respective one of the servers during the synchronization process.

A further embodiment of the invention provides a system that includes a plurality of servers, each storing one or more search result files, and a synchronizing server communicatively coupled to each of the servers and configured to synchronize the search result files among the servers such that upon conclusion of the synchronization each of the servers stores all of the search result files. A load balancer may be communicatively coupled to each of the plurality of servers.

### BRIEF DESCRIPTION OF THE DRAWINGS

The present invention is illustrated by way of example, and not limitation, in the figures of the accompanying drawings in which:

FIG. 1 illustrates an example of a system having a synchronizing server configured in accordance with an embodiment of the present invention;

FIGS. 2A-2C illustrate a portion of a search engine system, and examples of search queries being submitted thereto.

### DETAILED DESCRIPTION

Described herein are techniques for synchronizing cached search query results across multiple servers. Although the present invention will be discussed with reference to certain illustrated embodiments, it should be remembered that these embodiments are being presented as examples only. The present invention should be measured only in terms of the claims following this description.

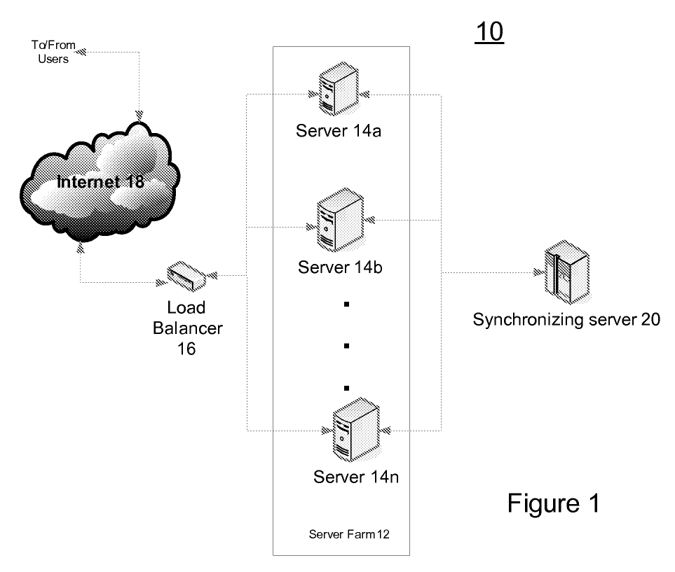

Referring now to FIG. 1, system 10 includes a server farm 12, which itself includes a number of servers 14a, 14b, . . . , 14n. Collectively, servers 14a-14n are used as resources by a search engine. That is, search queries submitted to the search engine are run against search indices stored at servers 14a-14n and results returned by these servers are presented to users. Typically, though not necessarily, each server 14a-14n will store identical copies of the search indices against which the queries are run. Optionally, the server farm 12 may be fronted by a load balancer 16, which acts to distribute search queries received from users (e.g., via the Internet 18) across the various servers 14a-14n according to conventional load balancing techniques known in the art.

Each server 14a-14n may be configured to cache its search results according to a conventional cache protocol. Hence, each of the servers may be configured to return previously cached results to queries that are the same as (or similar to) previously received queries. The servers may be configured to replace the cached search results periodically (e.g., in time or number of searches) so that the search results remain fresh from the standpoint of the users seeking the results. As is conventional in the industry, the cached search results may be stored in memory at each of the servers.

Unlike the conventional caching of search results, however, the present invention also provides for storing the cached search results at each server to disk. That is, each server 14a-14n is configured to store previously returned search result lists to local disks. The search result lists may be stored to appropriately labeled files, for example indexed by search query. Hence, each server may store many different files for all the search queries run at the respective server.

The present invention also provides for synchronizing the stored cache result files from each server. In the illustrated example, synchronizing server 20 is configured to retrieve from each server 14a-14n information regarding the stored search result files at each of those servers. In some cases this may be accomplished by retrieving the files themselves, or by retrieving a list of the files stored by each server. Synchronizing server 20 is further configured to compare the files stored by each of the servers 14a-14n and synchronize these files such that each of the servers 14a-14n will store copies of all of the files of each of the servers. That is, synchronizing server 20 is responsible for ensuring that each server 14a-14n stores a complete set of all of the search result files of each of the individual servers.

Of course several optional optimizations exist for this synchronizing process. As indicated above, the search result files may be labeled or otherwise indexed according to the search query that resulted in the file being created. Hence, by comparing these labels or indecies, synchronizing server 20 can ensure that no duplication of files results at the individual servers 14a-14n. So, if server 14a stores a search result file labeled “travel” and server 14b stores a file having the same label, synchronizing server 20 would not replicate the file from server 14a to server 14b (or vice versa) because each server already stores a search result file for the search query “travel”. Indeed, these files may be the result of a previous synchronization operation and, hence, would be expected to be identical. An exception to this rule exists in cases where a time to live or other staleness indicator associated with a file indicates that it should be replaced by a newer (fresher) search result file associated with a newer (fresher) search result.

A further optimization may have the actions of synchronizing server performed by one of the servers 14a-14n. That is, one of the servers 14a-14n may be tasked with performing the synchronizing operations described above (and its search load balanced accordingly). In some cases, the role of synchronizing server may be associated with a token such that the server 14a-14n possessing the token (e.g., won through an arbitration or other scheme) acts as synchronizer. The token may be reallocated according to an arbitration scheme if no synchronization operation occurs within a predetermined period of time (e.g., an indication that the existing synchronizing server has experienced a failure). Alternatively, or in addition, servers 14a-14n may be configured to pass the token if the current synchronizing server becomes aware that a failure is imminent.

The synchronization of the search result files may involve transferring the files of each server 14a-14n to the synchronizing server 20 (or other server) for distribution. That is, the designated synchronizing server may be tasked with transferring copies of the files to each server 14a-14n requiring same so that at the end of the process each of the servers 14a-14n has a locally stored copy of each unique search result file. Alternatively, the servers 14a-14n may be instructed by the synchronizing server to transfer designated files to each of the other servers 14a-14n so that this result is achieved.

Synchronizing operations may be performed periodically. For example, in one embodiment synchronizing operations are performed every few minutes so that each server maintains a very up-to-date set of search result files. In other embodiments, synchronizing operations may be performed more frequently or less frequently, according to the amount of activity at each server 14a-14n.

One benefit afforded by the present synchronization scheme is that there is no longer any single point of failure for cached search results. Each of the servers 14a-14n will retain a complete (or nearly complete depending on the length of time since the last synchronization operation) set of cached search results which an be returned in response to appropriate search queries. Should one of the servers fail, the other servers will retain the benefits of searches executed by that ser in the form of its cached result lists. Hence, the overall response time of the search engine may be reduced from that which it otherwise might be if each server stored only its own results lists.

A time to live or other freshness indicator may be associated with each of the cached results file. These indicators may be used by each of the server 14a-14n to determine when new searches for previously searched queries are required. The result will be a new search result file having the same label as an old (now invalid) search result file, copies of which will be stored at the other servers 14a-14n. To ensure these older files at the other servers are replaced by the newer search result file at the server where the search was most recently executed, the synchronizing server 20 may be configured to examine the time stamp or other indicator associated with each similarly labeled file and replace older files with newer versions thereof.

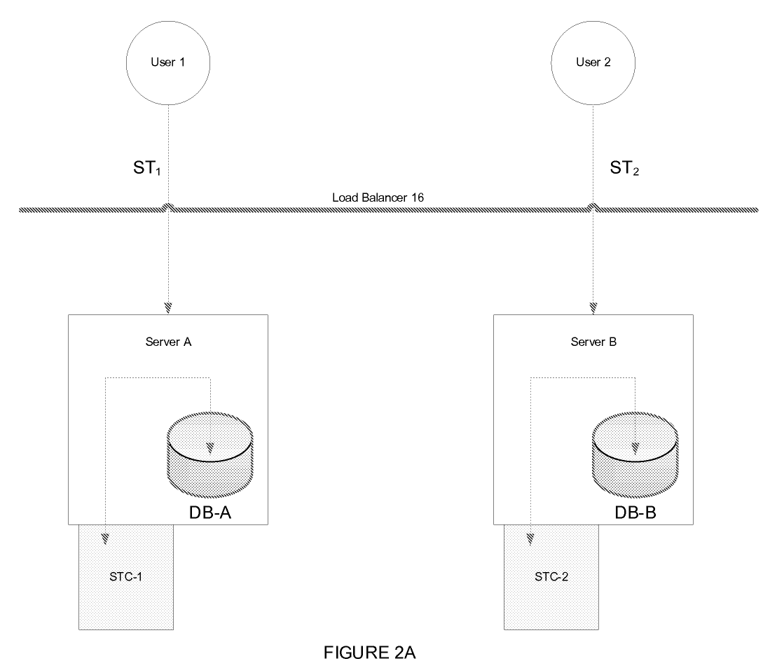

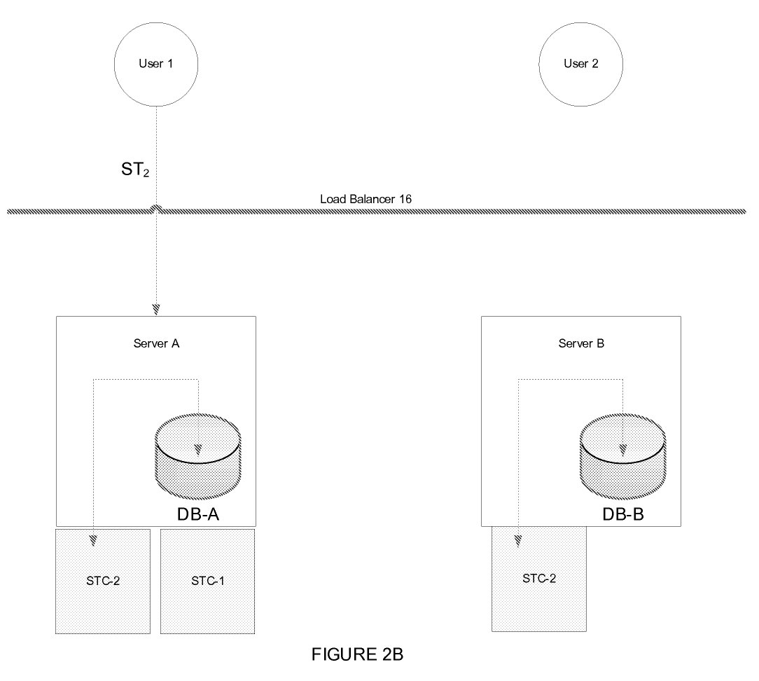

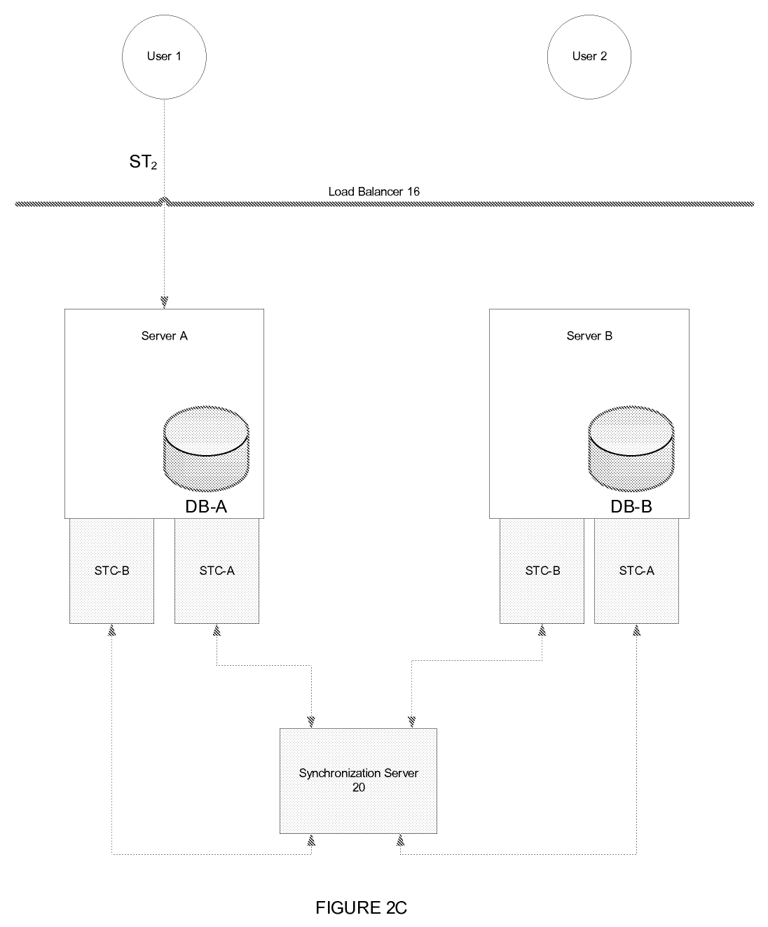

The following example may assist in understanding the benefits afforded by the present invention. Consider the network illustrated in FIG. 2A. For purposes of this explanation, only certain portions of what may be a much larger network are illustrated. The fact that other portions of a network are not shown, or that some network equipment may be illustrated only be a line should not be read as limiting the present invention.

On the left-hand side of the diagram, User-1 is shown submitting a search term, ST₁, to a search engine network that includes load balancer 16 and servers A and B. In this instance, load balancer 16 routes the request to Server A. Server A first determines whether or not it has previously stored results for ST₁ by looking for a related Search-Term-Cache-File-1 (STC-1) in its local database, DB-A. Assume for purposes of this example that Server A has not previously executed a search for search term ST₁ and, therefore, that STC-1 does not yet exist. As a result, Server A searches its data files using ST₁ as a search query and uses the results returned by the search to produce STC-1. STC-1 is subsequently stored at Server A.

On the right-hand side of the diagram, User-2 is shown submitting search term, ST₂, to the search engine network. In this instance, load balancer 16 routes the request to Server B. Server B first determines whether or not it has previously stored results for ST₂ by looking for a related Search-Term-Cache-File-2 (STC-2) in its local database, DB-B. Assume for purposes of this example that Server B has not previously executed a search for search term ST₂ and, therefore, that STC-2 does not yet exist. As a result, Server B searches its data files using ST₂ as a search query and uses the results returned by the search to produce STC-2. STC-2 is subsequently stored at Server B.

Now consider what happens when User-1 searches for ST₂ in a situation where no synchronization of search term cache files is used. This situation is depicted in FIG. 2B. User-1 enters ST₂ and load balancer 16 routes the request to Server A. Server A looks for a locally stored copy of STC-2, but none exists. Consequently, Server A is forced to search its data files using ST₂ as a search query and use the results returned by the search to produce a local version of STC-2. This new STC-2 is subsequently stored at Server A.

Both Server A and Server B now store copies of STC-2. If only a brief time has elapsed between that when Server B produced its copy of STC-2 and that when Server A produced its copy of STC-2, the two copies will be identical. However, the time taken for Server A to return search results for the ST₂ query by User 1 will have been much greater than that which would have been required if Server A had had access to Server B's copy of STC-2.

Likewise, if User-2 had entered ST₁ and the load balancer had routed that request to Server B, Server B would have searched for a locally stored copy of STC-1 and, having found none, would have had to run the ST₁ search, generate its own version of STC-1 and store it. Hence, without synchronization, Search-Term-Cache-File generation must take place for each search term on each server, independent of whether any other server has previously generated and stored the corresponding Search-Term-Cache-File.

Now consider the situation when synchronization techniques in accordance with the present invention are employed. As shown in FIG. 2C, some time after Server A has generated STC-1 and Server B has generated STC-2, a synchronization process (in this example perfomred by synchronization server 20) has synched up the STC files so that Server A and Server B each store local copies of all of the STC files.

Now, when User-1 enters ST₂, no matter which server (A or B) load balancer 16 routes the request to, that server will be able to return a copy of STC-2 rather than having to execute a new search based on ST₂. So, if load balancer 16 routes the request to Server A, Server A will locate its local copy of STC-2 and return same in response to the query. Likewise, if User-2 were to submit ST₁ and that request were routed to Server B, Server b would return its copy of STC-1. As indicated above, the STC files may be subject to certain time-to-live parameters, in which case the servers would periodically update their local copies of the STC files and the updated copies would ultimately be synchronized among the servers.

Thus, techniques for synchronizing cached search query results across multiple servers. Although the foregoing discussion made reference to certain illustrated embodiments, the present invention should be measured only in terms of the following claims.

What is claimed is:

1. A method, comprising synchronizing search result files among multiple servers so as to store at each of the servers copies of search result files stored by others of the servers.

2. The method of claim 1, wherein the synchronizing is performed periodically.

3. The method of claim 2, wherein in cases of search result files having similar labels, older ones of the similarly labeled search result files are replaced by newer ones thereof at each respective one of the servers.

4. A system, comprising a plurality of servers, each storing one or more search result files, and a synchronizing server communicatively coupled to each of the servers and configured to synchronize the search result files among the servers such that upon conclusion of the synchronization each of the servers stores all of the search result files.

5. The system of claim 4, further comprising a load balancer communicatively coupled to each of the plurality of servers.
